(19) United States
(12) Patent Application Publication
(10) Pub. No.: US 2025/0104476 A1
(43) Pub. Date: Mar. 27, 2025

(54) METHOD AND APPARATUS FOR DEEP LEARNING OF FOOT CONTACTS AND FORCES

(71) Applicant: INTERDIGITAL CE PATENT HOLDINGS, SAS, Paris (FR)

(72) Inventors: Lucas MOUROT, Rennes (FR); Ludovic HOYET, Noyal Sur Vilaine (FR); Francois LE CLERC, L'Hermitage (FR); Pierre Hellier, Thorigne-Fouillard (FR)

(21) Appl. No.: 18/730,822

(22) PCT Filed: Jan. 23, 2023
(86) PCT No.: PCT/EP2023/051586

§ 371 Date: Jul. 22, 2024

(30) Foreign Application Priority Data
Jan. 25, 2022 (EP) 22305080.8

(51) Int. Cl. G06V 40/20; G06T 7/246

(52) U.S. Cl. CPC G06V 40/25; G06T 7/246; G06T 2207/20044; G06T 2207/20081; G06T 2207/20084

(57) ABSTRACT

An approach to design a neural network estimates ground contact forces in various areas under each foot from motion capture data at an input. At training time, the input motion capture data is supplemented with synchronized pressure insole data and this extra data is leveraged to optimize neural network weights. At run-time, the optimized network is fed with motion capture data to regress the ground contact forces and predict more accurate ground contact from these forces. The data-driven foot contacts prediction method is learned on a large motion capture database which outperforms traditional heuristic approaches.

### TECHNICAL FIELD

At least one of the present embodiments generally relates to a method or an apparatus for deep learning of foot contacts with convolutional neural networks.

### BACKGROUND

Convolutional Neural Networks (CNNs) have allowed considerable progress in the processing of image, video, and time series signals. Their benefits in these fields have sparked an interest in deep learning such as for foot contacts.

### SUMMARY

At least one of the present embodiments generally relates to a method or an apparatus for deep learning of skeletal contacts with convolutional neural networks. In an exemplary embodiment, not limiting the general aspects, the skeletal contacts are described in terms of vertical foot contacts.

According to a first aspect, there is provided a method. The method comprises steps for training a deep neural network by determining vertical ground reactive force estimates from a database comprising motion information and ground reactive forces; applying the trained deep neural network to human motion data to generate vertical ground reactive force estimates; and, applying a contacts function to the vertical ground reactive force estimates to generate foot contact estimates

According to another aspect, there is provided an apparatus. The apparatus comprises a processor. The processor can be configured to implement the general aspects by executing any of the described methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a pressure cell layout and an example motion capture skeleton.

FIG. 2 illustrates an overview of the proposed contact prediction method from estimated vertical ground reaction forces.

FIG. 3 illustrates one embodiment of the training and inference processes.

FIG. 4 shows one embodiment of the general aspects to implement scene rendering with a thin client and server.

FIG. 5 illustrates one embodiment of a method for implementing the present aspects.

FIG. 6 illustrates one embodiment of an apparatus for implementing the present aspects.

### DETAILED DESCRIPTION

Convolutional Neural Networks (CNNs) have allowed considerable progress in the processing of image, video, and time series signals. Their benefits in these fields have sparked an interest in generalizing their application to other types of data, including data defined on non-Euclidean domains.

Perceived realism is central to human animation; however, different artefacts are often introduced whenever one tries to edit or synthesize motion data. Human perception being more sensitive to relative changes rather than absolute ones, artefacts taking place close to fixed reference points like walls or ground are generally more hurtful to perception. In this context foot contacts detection plays an important role to quantify foot artefacts and to provide animation tools robust with respect to those artefacts.

As of today, many motion synthesis and editing approaches suffer from such artifacts, e.g., foot sliding on, passing through or floating above the ground, and require knowing when the feet are in contact with the ground to post-process motion sequences. Usually, foot contacts are derived from motion sequences subject to artifacts themselves using simple heuristics that are hand-crafted thresholds over velocity and proximity relative to the ground. Unfortunately, these approaches suffer from three main limitations.

First, the terrain height map must be known, meaning that these approaches are most of the time not applicable to uneven or inclined ground. Second, optimal thresholds are not universal, meaning that they must be manually tuned, ideally for every type of motion, morphology, and contact location (e.g., heel or toe). Finally, even optimal thresholds fail at accurately detecting every foot contact, which implies that tedious manual checking is necessary when using these approaches.

Under the general aspects described here, an approach is proposed to design a neural network that estimates ground contact forces in various areas under each foot from motion capture data at the input. At training time only, the input motion capture data is supplemented with synchronized pressure insole data and this extra data is leveraged to optimize the neural network weights. At run-time, the optimized network is fed with motion capture data to regress the ground contact forces, and predict more accurate ground contact from these forces.

In the following described embodiments, the proposed data-driven foot contacts prediction method is learned on a large motion capture database which outperforms traditional heuristic approaches. First, we have constituted UnderPressure, a novel publicly available database composed of diverse motion capture data synchronized with pressure insoles data, from which corresponding vertical ground reaction forces (vGRFs) and foot contacts can be computed. Then, we train a deep neural network to predict GRF distribution from motion sequences.

The key idea here is that using a meaningful proxy representation, i.e., GRFs, richer than binary foot contacts will force the network to actually model the complex interactions between the feet and the ground rather than to find out optimal thresholds for instance.

Finally, accurate foot contact predictions can be computed from the predicted GRFs at inference. The proposed embodiments enable better accuracy of ground contact detection as it is based on fine-grained ground reaction forces, as opposed to motion capture joint locations.

In this approach, the estimation results can be used to improve the quality of the motion data. Based on contact detection results, skeletal motion sequences can be updated so that the feet are positioned on the ground plane and that the velocity of their joints is zero during contact. Inverse kinematics can be used to update the other body joints, for example.

We propose the first method for foot contacts detection learned on a significant amount of accurately labelled motion data.

It is the most accurate method for foot contacts detection as of today, providing correct foot contacts labels in locomotion over about 99 frames out of 100 as well as valuable vertical ground reaction forces exerted on the feet at each frame.

Some example applications for these embodiments are:
Correction of artefacts in generated/edited/retargeted human motion sequences, based on accurate foot contact detection results:
Footskating, penetration of the skeleton into the ground.
Accurate audio/video synchronization in cloud gaming applications involving moving characters (foot impact noise vs detected ground contact)
   Additionally, these embodiments could be used for increased realism of avatars, gaming, and movie postproduction.

TABLE 1
Categories of the motion sequences
constituting the proposed database.

| | | |
|---|---|---|
| Category | Motion Type | Duration [m] |

| | |
|---|---|
| idle | 1-leg stand-up |
| | 2-leg stand-up |
| | sit-down |
| | crouched down |
| standard | slow walking |
| locomotion | normal walking |
| | fast walking |
| | running |
| other | 1-leg hop |
| locomotion | 2-leg hop |
| | stairs 1 at a time |
| | stairs 2 at a time |
| standard | stepping on |
| locomotion | stepping over |
| with obstacles | 1-leg jumping over |
| | 2-leg jumping over |
| Total | |

### Motion Capture

For the purpose of training the neural network used for the prediction of foot contacts, we recorded motion capture data on a sample of adult volunteers equipped with motion capture sensors and performing a variety of movements including locomotion at different paces both forward and backward, sitting, chair climbing, jumping, as well as motions on uneven terrain like going up and down stairs.

### Foot Pressure

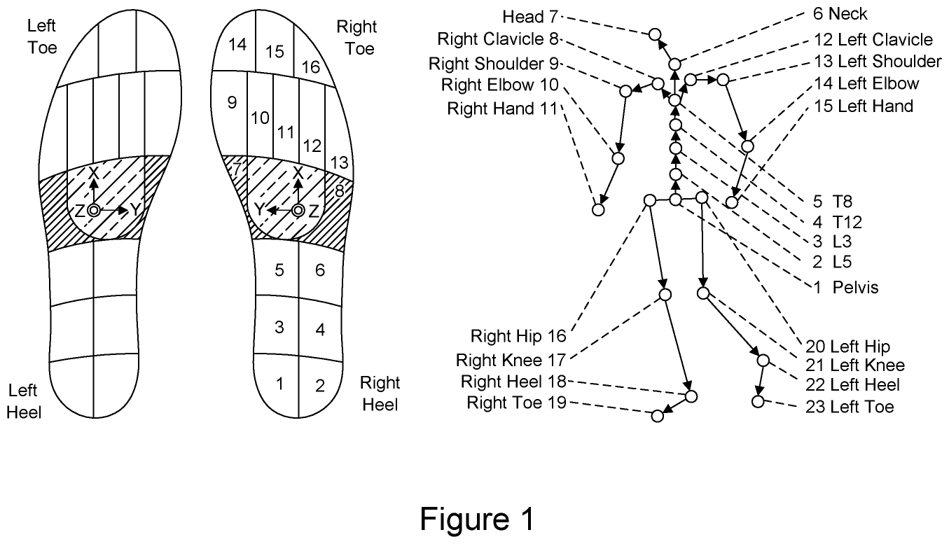

In addition to motion capture, we recorded plantar foot pressure distribution. To this end, subjects were also equipped with Moticon's OpenGo Sensor Insoles placed into their shoes. Each insole has 16 plantar pressure sensors with a resolution of 0.25 N/cm2 and a 6-axis inertial measurement unit (IMU), both running at 100 Hz (See FIG. 1a).

### Post-Capture Processing

Vertical GRFs captured data includes motion sequences, plantar pressure distribution and feet acceleration. Since pressure is defined as the perpendicular force per unit area, we additionally compute vertical GRF components (vGRFs) by multiplying pressure values by the corresponding cell areas. The motivation here is that groups of vGRFs are easier to aggregate, i.e., by summation.

### Binary Foot Contacts.

In order to define foot contact labels from insole records, we designed a robust deterministic algorithm which computes binary foot contact labels divided into heels and toes as commonly done in human animation. It roughly consists in considering heel or toe in contact with the ground when their corresponding total force (See FIG. 1a) is above 5% of their 9th decile. FIG. 1 (left) shows the pressure cell layout of Moticon's OpenGo Sensor Insoles. Cells (1 to 6) and Cells (9 to 16) are the groups of cells considered to compute heel and toe contacts, respectively. Axes at insole centers represent inertial measurement units (IMUs). FIG. 1 (right) shows Xsens MVN's motion capture skeleton with 23 joints.

### Synchronization.

Since we jointly captured motion and foot pressure data with separate devices, our records must be accurately synchronized in absence of a genlock signal. To this end, subjects were asked to perform a simple control movement at the beginning and end of each capture sequence for synchronization purposes. It consists of a small in-place double-leg jump allowing us to match vertical acceleration peaks measured on pressure insole IMUs and computed from motion capture foot position. Although numerical differentiation is known to amplify high frequency noise, we found that acceleration peaks were precise enough to accurately synchronize up to 1 insole frame, i.e. 10 ms.

### Resampling & Trimming.

After synchronizing our data, we resampled motion capture data from 240 Hz down to 100 Hz using spherical linear interpolation to match pressure insoles framerate. Though, we also provide original motion sequences at 240 Hz in our database. We also trim the beginning and end of each sequence which correspond to the synchronization movements.

### Method

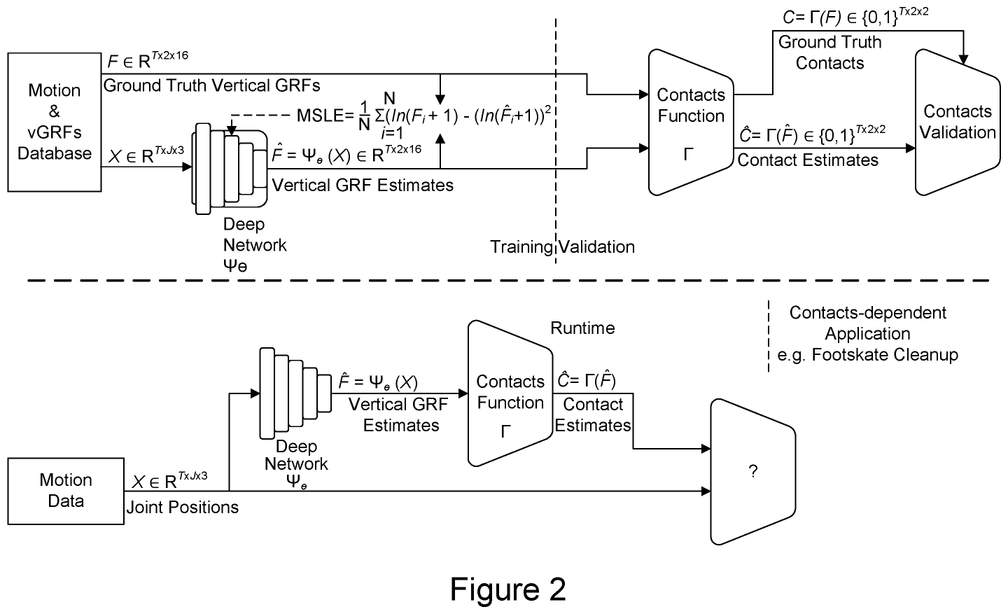

In this section, we describe the proposed method to learn a deep learning model of vGRF distribution prediction from motion capture data. vGRFs then serve as a rich proxy representation from which to compute robust and accurate binary foot contacts. FIG. 2 illustrates an overview of the proposed approach which shows the contact prediction method from estimated vertical ground reaction forces (vGRF). Rounded rectangles represent data while trapezoidal shapes are functions/processes. The deep network Ye is the only learned component of the processing scheme. The vGRFs then serve as a rich proxy representation from that part of the model.

### Data Representation

Input. At each frame t, the human pose Xt∈R/×3 is represented by the position of its J=23 joints in a global Euclidean space. We design our vGRFs prediction network ψθ to output vGRFs at each frame from a few surrounding input frames with padding when needed. The full input pose sequence is then X∈RT×J×3, where T is the number of frames.

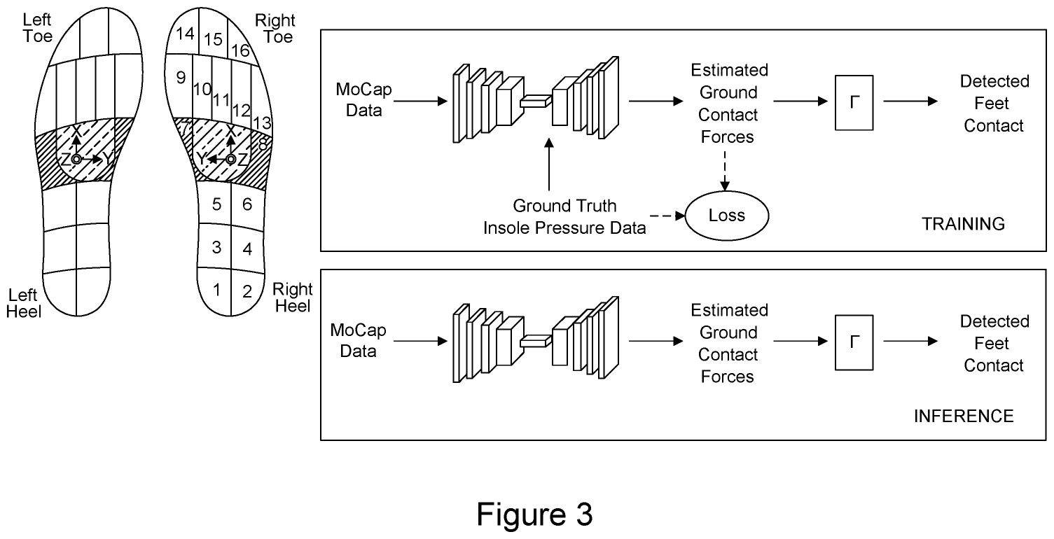

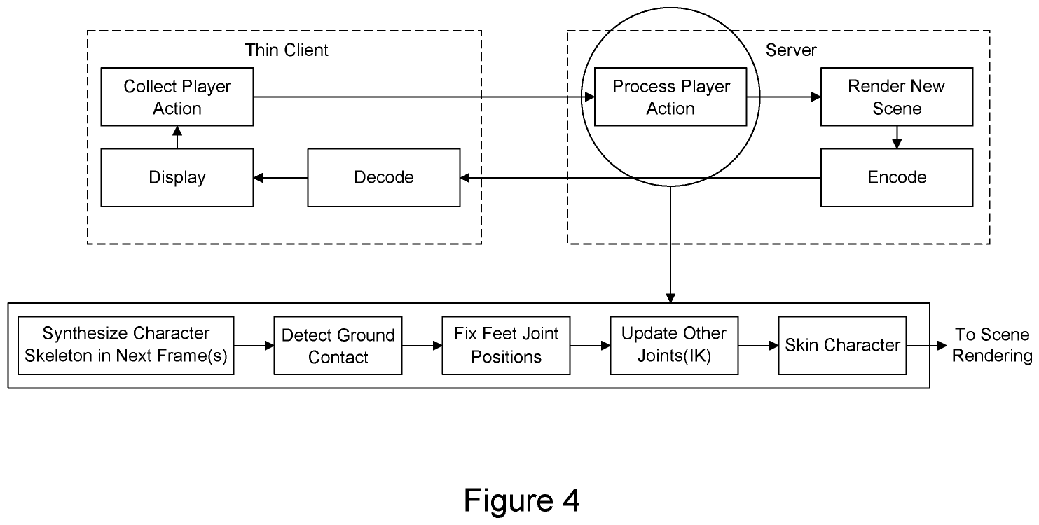

Output. As previously described, our vGRFs prediction network 40 estimates the vGRF distribution from motion data. At each frame, it outputs F\hat{ }=ψθ(X)∈RT×2×16, i.e. 16 positive real valued vGRF components at each frame for both feet, corresponding to the 16 insole pressure cells. At inference, we use the same deterministic algorithm, called contacts function I′, as the one we use to compute ground truth binary foot contacts from captured insoles data, to derive binary foot contacts c\hat{ }=Γ(F\hat{ })∈{0, 1} T×2×2 from estimated vGRFs at each frame, for both feet and both contact locations (heel & toe). FIG. 3 illustrates one embodiment of the training and inference processes. FIG. 4 shows one embodiment of the general aspects, to implement scene rendering with a thin client and server, as would typically be done in a cloud gaming application.

vGRFs Prediction Network

Architecture. We design our vGRFs prediction network 40 in order to process variable-length sequences. To this end, the network is composed of four 1D temporal convolutional layers followed by three linear layers shared across frames. Each layer is followed by exponential linear units (ELU) except the last one which is a softplus activation to output nonnegative vGRFs. Since we use 3-frame wide kernels in the convolutional layers, the intrinsic latency of the model is equivalent to 4 frames or 40 ms.

Training. During training, our network is iteratively exposed to sequences of human poses and tries predicting corresponding vGRFs as depicted in FIG. 2. To avoid complicated normalization procedure on network inputs while providing robust predictions from any input motions, we make use of random data augmentation. Similar to random crops and rotations used on images in computer vision, we apply random vGRF-invariant transformations on input pose sequences. These include horizontal translations and rotations as well as isotropic scaling. Such random data augmentation also helps to regularize the learning by preventing overfitting. We then use a reconstruction loss with respect to the ground truth vGRFs corresponding to input human poses. Instead of a standard mean squared error (MSE), we minimize the mean squared logarithmic error (MSLE). It has the property to only focus on about relative difference between target and predicted values (see right-hand side of equation 1), which is convenient when the values considered can be different orders of magnitude apart. In our case, actual vGRFs can be strictly positive and arbitrarily low (e.g., during transition from double leg to single leg stance) as well as very high (e.g., during jump landing). The loss function used to train our network is then:

$$ℒ = \frac{1}{N} {\sum }_{i = 1}^{N} {( ln ( {F}_{i} + 1 ) - ln ( {\hat{F}}_{i} + 1 ) )}^{2} = \frac{1}{N} {\sum }_{i = 1}^{N} {ln}^{2} ( \frac{{F}_{i} + 1}{{\hat{F}}_{i} + 1} ) \qquad ( 1 )$$

where F is the ground truth vGRFs and F\hat{ }=ψθ(X) its predicted counterpart. Note that for numerical convenience, 1 is added to both F and F\hat{ } since ln(0) is not defined while vGRFs can be zero.

TABLE 2
Quantitative results of our method, its variants
for ablative study purposes and the baseline we defined.
Columns F₁ and AUC respectively report the F₁ score (with-
out any temporal tolerence) and the area under the curve
obtained when computing F₁ scores with temporal tolerence
$from 0. s to {[ + ]}^{TBD} 0.1 s . Note that we normalize this area$
such that the maximum area equals to 1.

| Method | F₁ | AUC |
|---|---|---|
| OT | 0.8822 | 0.9786 |
| Shallow Feet | 0.9073 | 0.9855 |
| Shallow | 0.9161 | 0.9877 |
| DL Contacts | 0.9654 | 0.9969 |
| DL vGRFs | 0.9644 | 0.9967 |
| DL vGRFs&Contacts [C] | 0.9653 | 0.9962 |
| DL vGRFs&Contacts [F] | 0.9639 | 0.9963 |

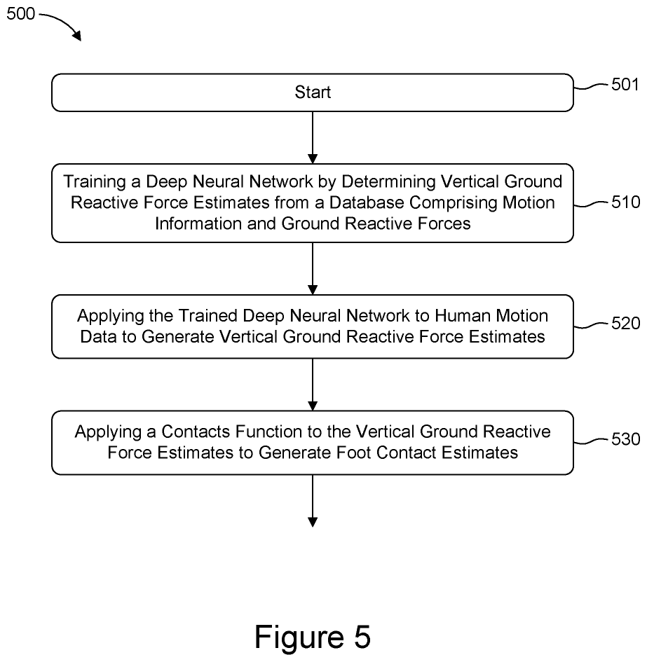

One embodiment of a method 500 under the described aspects is shown in FIG. 5. The method commences at Start block 501 and commences to block 510 for training a deep neural network by determining vertical ground reactive force estimates from a database comprising motion information and ground reactive forces. Control proceeds from block 510 to block 520 for applying the trained deep neural network to human motion data to generate vertical ground reactive force estimates. Control proceeds from block 520 to block 530 for applying a contacts function to the vertical ground reactive force estimates to generate foot contact estimates.

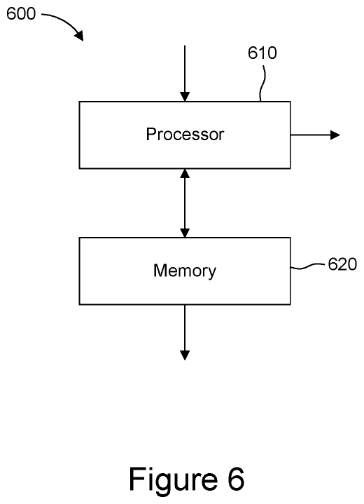

FIG. 6 shows one embodiment of an apparatus 600 for implementing the described aspects. The apparatus comprises Processor 610 and can be interconnected to a memory 620 through at least one port. Both Processor 610 and memory 620 can also have one or more additional interconnections to external connections.

Processor 610 is also configured to either insert or receive information in a bitstream and, either compressing, encoding, or decoding using any of the described aspects.

This document describes a variety of aspects, including tools, features, embodiments, models, approaches, etc. Many of these aspects are described with specificity and, at least to show the individual characteristics, are often described in a manner that can sound limiting. However, this is for purposes of clarity in description, and does not limit the application or scope of those aspects. Indeed, all the different aspects can be combined and interchanged to provide further aspects. Moreover, the aspects can be combined and interchanged with aspects described in earlier filings as well.

The aspects described and contemplated in this document can be implemented in many different forms. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined.

The embodiments can be carried out by computer software implemented by the processor 610 or by hardware, or by a combination of hardware and software. As a non-limiting example, the embodiments can be implemented by one or more integrated circuits. The memory 620 can be of any type appropriate to the technical environment and can be implemented using any appropriate data storage technology, such as optical memory devices, magnetic memory devices, semiconductor-based memory devices, fixed memory, and removable memory, as non-limiting examples. The processor 610 can be of any type appropriate to the technical environment, and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “determining” various pieces of information. Determining the information can include one or more of, for example, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Embodiments may include one or more of the following features or entities, alone or in combination, across various different claim categories and types:
Training a deep neural network by determining vertical ground reactive force estimates from a database comprising motion information and ground reactive forces.
applying the trained deep neural network to human motion data to generate vertical ground reactive force estimates.
Applying a contacts function to the vertical ground reactive force estimates to generate foot contact estimates
A TV, set-top box, cell phone, tablet, or other electronic device that performs according to any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image, and performs in-loop filtering according to any of the embodiments described.
A TV, set-top box, cell phone, tablet, or other electronic device that receives (e.g., using an antenna) a signal over the air that includes an encoded image, and performs in-loop filtering according to any of the embodiments described.

Various other generalized, as well as particularized, inventions and claims are also supported and contemplated throughout this description.

1. A method of predicting foot contact data, comprising:
training a deep neural network by determining skeletal reactive force estimates from a database comprising motion information and skeletal reactive forces.

2. An apparatus for predicting foot contact data, comprising:
memory; and,
a processor, configured to perform:
training a deep neural network by determining skeletal reactive force estimates from a database comprising motion information and skeletal reactive forces.

3. A method, comprising:
applying a trained deep neural network to human motion data to generate skeletal reactive force estimates; and,
applying a contacts function to the skeletal reactive force estimates to generate body contact estimates.

4. An apparatus comprising a memory and a processor, configured to perform:
applying a trained deep neural network to human motion data to generate skeletal reactive force estimates; and,
applying a contacts function to the skeletal reactive force estimates to generate body contact estimates.

5. The method of claim 1, wherein the skeletal reactive forces are vertical ground forces.

6. The method of claim 1, wherein the human motion data comprises foot pressure data.

7. The method of claim 1, wherein the human motion data is positioned at multiple points in a global Euclidean space.

8. The method of claim 1, wherein the human motion data comprises points from a frame and multiple surrounding frames in a global Euclidean space.

9. The apparatus of claim 2, wherein said deep neural network is comprised of multiple temporal convolutional layers followed by linear layers shared across frames.

10. The apparatus of claim 4, wherein said training comprises applying random vertical ground reactive force-invariant transformations on input sequences.

11. The apparatus of claim 4, wherein said training further comprises minimizing mean squared logarithmic error.

12. The apparatus of claim 4, wherein a contacts function is used to validate ground truth contacts with contact estimates.

13. The method of claim 3, wherein the skeletal reactive forces are vertical ground forces.

14. The method of claim 3, wherein the human motion data comprises foot pressure data.

15. The method of claim 3, wherein the human motion data is positioned at multiple points in a global Euclidean space.

16. The method of claim 3, wherein the human motion data comprises points from a frame and multiple surrounding frames in a global Euclidean space.

17. The apparatus claim 4, wherein said deep neural network is comprised of multiple temporal convolutional layers followed by linear layers shared across frames.

18. The apparatus claim 4, wherein said training comprises applying random vertical ground reactive force-invariant transformations on input sequences.

19. The apparatus claim 4, wherein said training further comprises minimizing mean squared logarithmic error.

20. The apparatus claim 4, wherein a contacts function is used to validate ground truth contacts with contact estimates.
